(19) United States
(12) Patent Application Publication
(10) Pub. No.: US 2015/0112738 A1
(43) Pub. Date: Apr. 23, 2015

(54) RESERVING VENUE FOR CALENDAR EVENT

(71) Applicant: LiquidSpace, Inc., Palo Alto, CA (US)

(72) Inventors: Douglas Marinaro, Medina, MN (US); Scott Colestock, Andover, MN (US); James Swanson, Eagan, MN (US); Aleksandra Marchenko, San Jose, CA (US); Mark Gilbreath, Ketchum, ID (US)

(21) Appl. No.: 14/518,858

(22) Filed: Oct. 20, 2014

Related U.S. Application Data
(60) Provisional application No. 61/893,875, filed on Oct. 21, 2013.

(51) Int. Cl. G06Q 10/02

(52) U.S. Cl. CPC G06Q 10/02
USPC 705/5

(57) ABSTRACT

Provided is a system for reserving a venue for a calendar event. The system may comprise a processor and a database. The processor may be configured to receive an invitation to the calendar event from an event organizer, gather data about the event, and define event requirements based on the data. Based on the event requirements and a permission of the organizer, the processor determines suitable venues. The suitable venues are ranked based on information on the organizer, invitees, event data, and venue data, and optimal venues are identified. A predefined number of optimal venues is sent to the organizer. The organizer selects a venue from the presented options and provides payment information. The processor reserves the selected venue and collects a payment using the payment information. The database stores at least available venues, the data about the calendar event, event requirements, suitable venues, optimal venues, and the selected venue.

### CROSS-REFERENCE TO RELATED APPLICATIONS

The present utility patent application is related to and claims priority benefit of the U.S. provisional application No. 61/893,875, filed on Oct. 21, 2013 under 35 U.S.C. 119(e). The contents of this related provisional application are incorporated herein by reference for all purposes to the extent that such subject matter is not inconsistent herewith or limiting hereof.

### FIELD

This application relates generally to data processing and, more specifically, to reserving a venue for a calendar event. BACKGROUND

Finding an optimal venue for an event may be a time-consuming and tedious task due to the varying requirements and schedules of potential attendees. Finding a time that fits the schedule of all the participants has become easier with calendaring software. However, finding an optimal meeting venue has become even more complex as organizations become more distributed and the number of meeting room options expanded. Some existing systems may allow scheduling rooms in calendar software applications by treating rooms like people. In these applications, users can enter the room's name and view the room's calendar along with the calendar for the meeting attendees to try to identify an open time slot. If the rooms that the user is familiar with are busy, the user can continue entering rooms until an open time slot is found. However, there is presently no search capability to match the availability of attendees against the availability of all potential meeting room options. Furthermore, the information concerning the venue choice is limited to the room name. There is no additional information to assess room options in view of the meeting purpose.

Alternative existing systems may allow searching for event venues by room availability for a specific time, but such systems are often independent of the calendar. This may lead to redundant data entry, synchronization difficulties, and delays in update of calendar event data.

Moreover, recurring calendar events may create additional difficulties since calendar software applications may only schedule a single room for all recurring events, therefore, limiting choices to rooms that are available for all occurrences of the event. On the other hand, planning recurring events using third party systems may lead to calendar synchronization difficulties.

Moreover, calendaring software applications and alternative existing systems may limit the set of meeting room choices to those meeting rooms that are under direct control of the business running the calendaring software. For example, an employee of a business may only consider the availability of meeting rooms where the meeting room schedule is managed by the business. Thus, the employee is not exposed to any of the meeting rooms that are available outside the control of the business, such as those available at executive suites, hotels, and other venues in the business of space or those available at other businesses with which they have a relationship. This limits the options venue options and requires the business to needlessly acquire additional meeting room space often through expensive long-term leases.

Additionally, conventional systems are mainly intended for meetings, so searching for venues intended for different events may be complicated.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for searching for and reserving a room for a calendar event. The method for reserving a venue for a calendar event may comprise receiving an invitation to the calendar event from an event organizer. Data associated with the calendar event may be gathered by the processor. The data may include date and time of the calendar event, number and identity of invitees to the calendar event, desired location of the calendar event, and so forth. Based on the gathered data, event requirements may be defined. The processor may use the event requirements as search criteria to find suitable venues for the calendar event. Additionally, the processor may consider permissions associated with the event organizer to filter out venues which are not covered by the permissions. Identified suitable venues may be analyzed to select several suitable venues based on historical information of the organizer and invitees, recommendations and opinions of other users, and so forth. The selected venues may be presented to the event organizer (for example, by e-mail, web site, or mobile app). A selection of one of the suitable venues and payment information associated with the event organizer may be received by the processor and, based on the selection, the processor may reserve the selected venue. When the reservation is finished, the data associated with the calendar event may be updated correspondingly and a payment amount associated with the selected venue may be collected using the payment information. The payment amount may be may be collected from the event organizer or from an account associated with a corporate member group to which the event organizer belongs. The payment amount can depend on the time booked (the best price can be automatically calculated depending on the number of hours, days, or months). The system for reserving a venue for a calendar event may collect the payment amount that depends on who the organizer is (different pricing for different people), whether the event organizer has used a coupon (discount), can include taxes as required, and in the currency of the country of the venue. The system may add a service fee associated with an assistant of the booking (e.g. an affiliate channel) to the payment amount. The system may deduct commissions from the rental fee depending on the event organizer and relationship with the venue owner. A payment to the venue can be made at the end of the month. The payment to the venue can include the amount collected minus the commission. However, the payment to the venue can include the taxes that the venue is responsible for paying to a local regulator.

The permissions associated with the venue may be related to hours of operation, days of access, a lead time before a reservation can be made, an allowed payment method, transactions associated with the reservation, cancellation policies, workspaces available within the venue, a payment amount, and other rules concerning access to the venue. The permission may be different for different event organizers and/or invitees.

Additionally, upon receiving changes to the calendar event, changed event requirements may be defined. The suitability of the selected and reserved venue for the changed event requirements may be checked and if the selected venue is suitable, a confirmation of the venue may be provided. In the selected venue is no longer suitable, the changed event requirements may be used to determine new suitable venues, and new venues may be presented to the event organizer to be selected and reserved.

In further exemplary embodiments, modules, subsystems, or devices can be adapted to perform the recited steps. Other features and exemplary embodiments are described below.

### BRIEF DESCRIPTION OF THE DRAWINGS

Embodiments are illustrated by way of example and not limitation in the figures of the accompanying drawings.

FIG. 1 illustrates an environment within which systems and methods for reserving a venue for a calendar event can be implemented.

FIG. 2 is a block diagram showing various modules of the system for reserving a venue for a calendar event.

FIG. 3 is a flow chart illustrating a method for reserving a venue for a calendar event.

FIG. 4 illustrates an example screenshot of a calendar event.

FIG. 5 illustrates an example screen for presenting suitable venues for an event organizer.

FIG. 6 illustrates an example screen of an updated calendar event.

FIG. 7 illustrates an example screen of a recurring calendar event.

FIG. 8 illustrates an example screen for presenting suitable venues for a recurring event.

FIG. 9 illustrates example screens for reserving a workplace.

FIG. 10 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

Systems and methods for reserving a venue or a calendar event are described herein. A calendar event may include a meeting, a conference, a work session, a restaurant reservation, a training session, a trip, an individual work session of the organizer, a long-term office lease, or another event that is associated with a certain number of people meeting in a particular place or one person using a particular place with some amenities. The venue may also be reserved without a specific event for predetermined extended periods or periods determined in the future. A system for reserving a venue for a calendar event may be based on venue availability and may communicate with a calendar service to gather calendar event data and make updates accordingly. The event organizer, who naturally uses an existing (and familiar and/or approved) calendar service to schedule an event based on the availability of the attendees, schedules an event in the existing calendar service. As part of scheduling the event, the event organizer can invite the system as an additional attendee using an email address associated with the system. Such a system may interpret the invitation as a request to reserve a venue for the event organizer. Upon receiving the invitation, the system may retrieve event data (e.g. date, time, number of invitees, identities of the organizer and invitees, custom description, and so forth) from the calendar service. Additionally, the system may retrieve data related to permissions of the event organizer associated with the venues. Based on the data and the permissions, the system may search for venues suitable for the calendar event. The suitable venues may include venues that grant permissions to the event organizer to reserve a venue through a procedure of trusted sharing. A plurality of suitable venues may be then processed using a recommendation algorithm. To identify a limited number of optimal venues to be presented to the organizer and invitees, the recommendation algorithm may use inputs received and the past behavior and preferences of the organizer and the attendees, policies of the organizations they belong to, policies of the venues being searched, and behavior and preferences of people who are associated with or are similar to the organizer and attendees as well as ratings of the rooms. A predefined number of found optimal venues may be presented to the event organizer. Interaction between the system and the event organizer can be accomplished via e-mail, web site, mobile applications, mobile communications, and so forth. The event organizer may select one of the presented rooms and immediately book the selected venue via the system. The system may update the event data in the calendar service to inform invitees about the venue where the event will take place. The event data may include information associated with the transaction (e.g. receipt for room rental), information concerning directions to the room including directions to the building and way-finding within the building, information concerning the set-up for the venue or the event that will take place in the venue, information concerning operations of the venue including climate controls, video equipment, bathrooms, exits, information concerning the potential attendees' statuses with respect to attending the event (e.g., running late, checked in). This information may ensure an optimal meeting experience.

Additionally, the system may handle changes that may be associated with the event. For example, the date and/or time of the event may be changed by the event organizer in the original calendar service. The system may receive an email as an attendee that the event has changed. The system can interpret this email and determine whether to take action to either re-confirm the venue or suggest an alternative venue. In this case, the system may check whether the selected venue is still available for the changed date and/or time. If the selected venue meets the changed requirements, a confirmation of the venue reservation may be sent to the event organizer and, possibly, the invitees. Otherwise, the system may repeat the venue search for the changed requirements and present the event organizer with new reservation options that meet the changed requirements. The system may also alert the owner or manager of the venue to the changes in the schedule to ensure that the venue is prepared for the attendee.

Furthermore, the disclosed systems and methods can be used to provide a private marketplace for a company's dedicated workspaces, designed to help manage the utilization of company real-estate assets and productivity of employees. The company can determine who has access to viewing and booking spaces within the company marketplace. This approach can allow improving the way the company searches for and books meeting rooms in its own buildings. This approach may also allow offering more options to workers and meeting organizers outside leased or owned space of the company and turn unused space into an asset by renting it to other organizations and mobile professionals. The company may also quickly respond to changing business conditions by adding or subtracting space as needed. The disclosed systems and methods may, therefore, help mobile professionals, venue owners, and large enterprises break through real estate boundaries and embrace the changing workplace landscape. It creates a marketplace that allows corporate real estate departments to join the shared economy by placing their workspaces into a private marketplace.

Additionally, on-demand access to partner or public workspaces allows companies to extend their reach and get more from their existing assets.

The disclosed technology provides a solution for the mobile workforce, dynamically matching people to optimal workspaces. Trusted workspaces may be available on demand by hour, day or extended stay. Workspaces may be promoted and merchandised with pictures, ratings, amenities, pricing, discounts, and more. A user may pay by a credit card or use a central billing location and choose from a growing and diverse array of venues, including preferred venues.

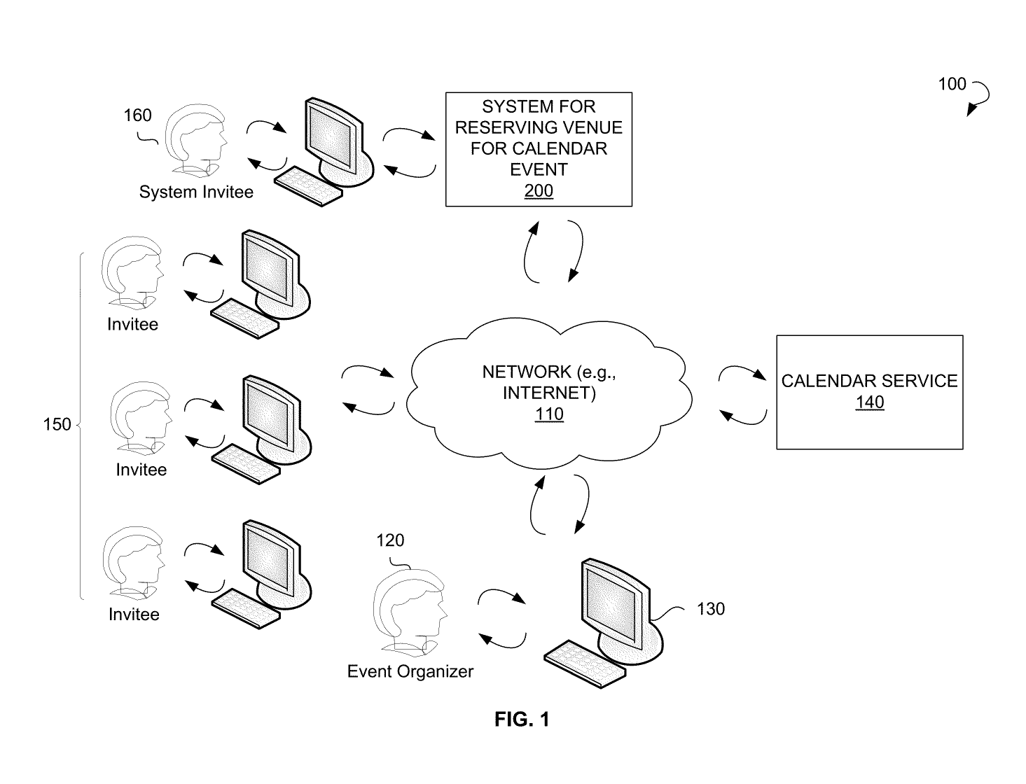

Referring now to the drawings, FIG. 1 illustrates an environment 100 within which the systems and methods for reserving a venue for a calendar event can be implemented. The environment 100 may include a network 110, an event organizer 120, a client device 130, a calendar service 140, one or more invitees 150, a system 200 for reserving a venue for a calendar event, and a system invitee 160 email address. The network 110 may include the Internet or any other network capable of communicating data between devices. Suitable networks may include or interface with any one or more of, for instance, the Internet, a local intranet, and so forth.

The client device 130 may include a mobile telephone, a computer, a laptop, a smart phone, a tablet PC, and so forth. The client device 130, in some example embodiments, may include a Graphical User Interface (GUI) for displaying the user interface associated with the calendar service 140 (for example, Outlook, Gmail, and so forth) and/or the system 200. The event organizer 120 may interact with the calendar service 140 and the system 200 via a GUI.

The event organizer 120 may create an event in his normal calendar service 140. Alternatively, the event organizer may enter the requirements for a space for an event directly into the system 200 through client 130 and network 110, thereby bypassing the calendar service 140. As part of creating the event, the event organizer 120 invites invitees 150. Additionally, the event organizer 120 may invite the system invitee 160. The description of the event may follow the standard format of the calendar service 140, for example, consistent with the .ICS standard to include email addresses for the organizer, email addresses for the invitees, the start and end dates and times for the event, the title of the event, the location field, and the description field. The system 200 can periodically poll the system invitee 160 email box to determine if any events have been posted. When an event is posted, the system 200 can read the standard format for the event that has been received by the system invitee 160 and interpret the fields of the .ICS format event.qw

The system attempts to match the identity of the event organizer 120 with a user in the system 200. Each user in the system 200 may be granted permission to use particular collections of workspaces known as venues. Venues may be in the purview of control of the event organizer's organization (e.g. their corporate campus) or outside the control (e.g. a hotel or private property belonging to another organization). By controlling access to various venues with permissions, the single system 200 may manage multiple venues for multiple users. The permissions may include at least one data object associated with each individual and each venue. Granting permissions may be facilitated by publishing a list of potential individuals to be invited to the venue, an invite to a specific individual, the venue granting the permissions to a group whose membership may change overtime (such as all employees of a specific company), the venue granting the permissions at the time of the reservation based on a profile of the user and other information provided upon request of the user, including possible acceptance of additional terms for the use of the venue, the venue granting the permissions to anyone who is recognized by the reservation system as an acceptable event organizer, and so forth.

In certain embodiments, the permissions can be determined by how the individual first encounters the system. Thus, the permissions may include several types, for example, permission type A for the venue can be granted to users who are invited by the venue, permission type B for the venue can be granted to users who has discovered the venue as a result of a query entered in a search system (e.g., LiquidSpace), permission type C for the venue can be granted to users who are members of a particular group.

The permissions may allow the venue listing to be visible to everyone or visible only to those who are invited and, otherwise, hidden to the world. Furthermore, everyone can be automatically granted permissions when first reserving or permissions can be granted based on the user profile provided upon making a reservation and/or based on answers to questions that the venue chooses to ask, reservations can be made conditional on proper permission, and so forth.

The permissions can specify policies specific to the holder of the permissions including the hours of availability, a lead time before the reserving is made, a payment method allowed, cancellation policies, workspaces available within the venue, a payment amount (including no payment), and so forth. The permissions may vary depending on the event organizer.

For example, user A may have permissions for venues 1, 2, and 5. User B may have permissions for venues 2, 3, 4, and 5. User A's permission for venue 2 may only allow access Monday through Friday from 9AM to 5PM. User B's permission for the same venue 2 may allow access all week long from 7AM to 7PM.

The system 200 may include a central calendar for each workspace including reservations made for that workspace by any users that has a permission to be able to reserve time for that workspace. The system 200 can evaluate the calendar for all the workspaces that the event organizer 120 has permission to use against the start and end times for the event to determine which workspaces are available for the event organizer 120.

The system 200 may further narrow the list of the potential workspaces by considering the capacity of the workspaces against the number of attendees at the events which include the invitees 150 and the event organizer 120. The system 200 may further narrow the list of potential workspaces by considering the location field of the event invitation .ICS file that is sent. The location field may include a text string which is interpreted as a command line by the system 200 to narrow the search. The text location command line can include city, state, address, company name, venue group recognized by the system, amenities, room capacity, and other commands that can be interpreted by the system 200.

The system 200 can employ a recommendation algorithm to recommend a limited number of meeting rooms including, but not limited to, the prior reservation history of the event organizer 120 and the invitees 150, ratings for the workspaces by the event organizer 120, invitees 150 and others, policies and preferences of an organizations that the event organizer 120 and invitees 150 may work for, and information concerning the venue and workspace relative to the time, location, and location field including distance, price, capacity, amenities, ratings, and other qualities.

The system 200 may then respond to the event organizer 120 via email, mobile app, test message, web interface or the like with the recommended venue. The response may occur within a short time, for example, few seconds, of the original event being scheduled. The event organizer 120 may provide his or her payment information for the system 200 to collect a payment amount for using the venue.

One or more invitees 150 may include contacts that are associated with the event organizer 120 and invited by the event organizer 120 to the calendar event. The invitees 150 may access data of the calendar event via the calendar service 140.

For example, the event organizer 120 may have a meeting coming up in New York. The event organizer 120 may enter the term “New York” into the location field of Calendar Service 140 or directly using an application associated with the system 200. The application may return a plurality of workspaces in New York. The event organizer 120 may decide to narrow down results just to the meeting rooms. Additional details may be provided to narrow down the results even further. For example, the results can be limited to a date, time, duration, and number of people. In some embodiments, the event organizer 120 may sign in with his/her corporate credentials so that the system 200 narrows results to the meeting spaces approved by the company. The approved meeting spaces may include meeting spaces of the company or meeting spaces available through a partner company. The system 200 may allow creating a reservation based on provided requirements. Once the meeting is set up, the system 200 may provide directions not only to the building but also within the building where that meeting space is located.

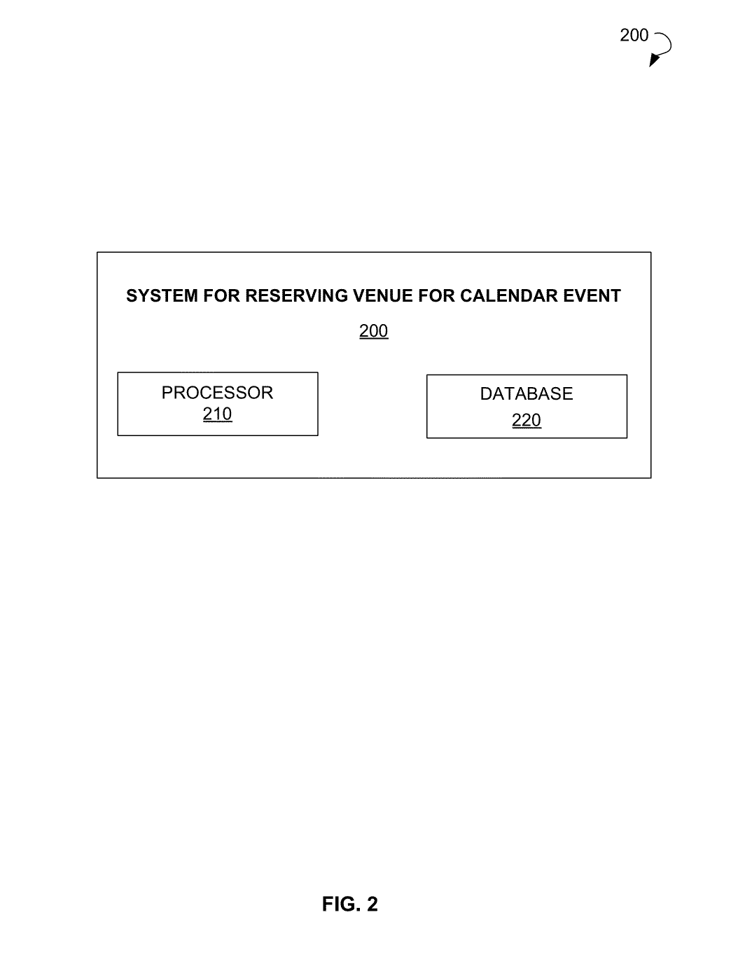

FIG. 2 is a block diagram showing various modules of the system 200 for reserving a venue for a calendar event, in accordance with certain embodiments. The system 200 may comprise a processor 210 and a database 220. The processor 210 may include a programmable processor, such as a microcontroller, central processing unit (CPU), and so forth. In other embodiments, the processor 210 may include an application-specific integrated circuit (ASIC) or programmable logic array (PLA), such as a field programmable gate array (FPGA), designed to implement the functions performed by the system 200.

In various embodiments, the system 200 may reside on the network of the organization or reside outside the organization in a data center outside the control of the company and be provided as a cloud service. By residing in the “cloud”, the system 200 may be able to include a marketplace of venues not just the venues under control of the organization. The system 200 is an integrated service that provides one marketplace with all private and public assets. The system 200 can allow managing the marketplace from an easy to use self-serve administration console. The processor 210 may receive an invitation to the calendar event from an event organizer. Alternatively, the processor 210 may receive a request for the venue, which includes general requirements without a specific period of time. The processor 210 may gather data associated with the calendar event invitation it received as well as the event organizer permissions and, based on the gathered data, define one or more requirements for venues to be found for the event. For example, the requirements may include event time and date, event location (city, area, specific district), venue capacity (maximum number of people), amenities (projector, board, WiFi), and so forth. The processor 210 may determine a plurality of suitable venues that meet the event requirements and correspond to the permissions of the event organizer and select a predetermined number of venues based on various criteria. For example, the system 200 may consider prior reservation history of the event organizer and the invitees, the ratings for the workspaces by the event organizer, invitees, and others, policies and preferences of an organizations that the event organizer and invitees may work for, and information concerning the venue and workspace relative to the time, location, and location field including distance, price, capacity, amenities, ratings, and other qualities. The predetermined number of suitable venues may be presented to the event organizer. The venues may be presented together with detailed data, including one or more photographs and/or video items, description, a venue calendar, the map to the building and to the room, the host for the venue, the amenities for the venue, the description of the venue, the ratings for the venue, and so forth. The detailed data about the venue may be entered directly by the owners and administrators of the venue through interfaces in system 200 and/or may be gathered automatically from information available publicly and digitally on the Internet by system 200 based on data entered about the venue.

A venue selection may be received from the event organizer, and the processor 210 may reserve the selected venue. Information on available venues, the data associated with the calendar event, the event requirements, the one or more suitable venues, and the selected room may be stored in the database 220 and may be accessible for the event organizer and/or invitees via a calendar service, web site, application, or newsletters associated with the system 200 for reserving room for calendar event. The database may further store information about members (e.g. potential organizers), their permissions, their booking preferences and history, payment profiles, people they are connected to (e.g., via a social network), and so forth.

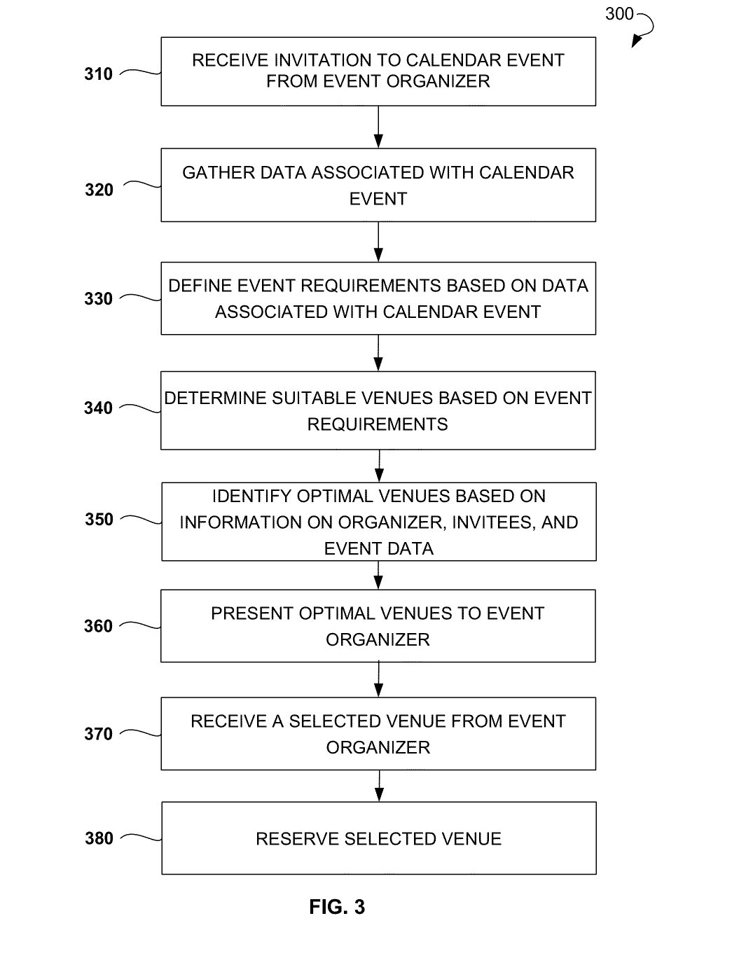

FIG. 3 is a flow chart illustrating a method 300 for reserving room for calendar event, in accordance with some example embodiments. The method 300 may be performed by logic that may comprise hardware (e.g., dedicated logic, programmable logic, and microcode), software (such as software run on a general-purpose computer system or a dedicated machine), or a combination of both. In one example embodiment, the processing logic resides at the system 200 for reserving room for calendar event, and the various elements of the system 200 can perform the method 300. It will be appreciated by one of ordinary skill that examples of the foregoing modules may be virtual, and instructions said to be executed by a module may, in fact, be retrieved and executed by software. Although various elements may be configured to perform some or all of the various operations described herein, fewer or more elements may be provided and still fall within the scope of various embodiments.

As shown in FIG. 3, the method 300 may commence at operation 310 with receiving invitation to a calendar event from event organizer via a calendar service. The event organizer may create the calendar event using the calendar service and input data associated with the event, for example, desired event location, date and time, duration, time zone, invited persons, amenities, and so forth.

By specifying the system 200 as one of the invitees, the event organizer may invite the system 200 to assist in venue reservation. At operation 320, the system 200 may gather data from the calendar event definition provided to all invitees to get context for the assistance. Thus, the system 200 may use date, time, number of invitees, identity of organizer, and identity of attendees as input to a best match search for meeting venue alternatives.

Based on the gathered data, event requirements may be defined at operation 330. For example, the system 200 may use standard fields like ‘Location/Where’ as input to a best match search for meeting room alternatives that are in the geography specified by the ‘Location/Where’ field.

The search may be performed through a pool of available venues based on the event, the implicit and explicit criteria for the event, permissions to access the venue for the event organizer, and the profile of the participants matched against the characteristics of the potential venues.

The search results may be ranked to provide easy and quick selection, reservation, rental (if needed), and confirmation of the venue. The rank order may be determined based not only on the explicit and implicit requirements for the venue but also the reservation history of the organizer, the relevance of the room characteristics to the search requirements, the quality of the room as measured by those socially connected to the organizer, and other criteria.

At operation 340, suitable venues may be determined based on the explicit and implicit requirements and permissions. For this purpose, the system 200 may perform a best match search among a plurality of available venues, data of which is stored in the database of the system 200, or look for matches within databases and networks, e.g. Internet. The suitable venues may be analyzed according to prior reservation history of the event organizer and the invitees, the ratings for the workspaces by the event organizer, invitees, and others, the policies and preferences of an organizations associated with the event organizer and invitees, and information about the venue and workspace relative to the time, location, and location field including distance, price, capacity, amenities, ratings, and other qualities. At operation 350, optimal venues may be identified based on the analysis.

The identified optimal venues may be presented to the event organizer at operation 360. In some embodiments, the optimal venues may be presented via e-mail. Alternatively, the presentation may be made via the calendar service, web-service, mobile application, and so forth. The number of the presented venues may be predefined so that the event organizer receives information only on, for example, three optimal venues. However, more variants may be available to the event organizer upon request.

The presented information may include venue photos and/or videos, video tours, descriptions, floor area, seat capacity, maps of the building and venue, provided amenities, and so forth. Additionally, the presented information may include a control element to reserve the venue directly. By activating the control element associated with one of the presented venues, the event organizer may select a venue. At operation 370, the selected venue may be received from the event organizer, and the selected venue may be reserved at operation 380. Additionally, the event organizer may provide payment data to pay for the venue reservation. Additionally, the payment information may include an authorization for the collection of the payment amount. The authorization may be provided individually by the event organizer or by a sponsor of a group where the payment amount is charged against one account.

A payment amount associated with the reservation to be provided to the event organizer may be determined by a price set by the venue, a duration of the calendar event associated with the selected venue or the calendar event, (e.g., a 6 month lease may be associated with a discount), the permissions granted by the venue, a tax rate entered by the venue, discounts applied to the reservation, and so forth. The price provided to the event organizer may be determined as a minimum price of the venue according to the event requirements. The price set by the venue can be different based on different time frames of the reservation (e.g., hourly, half-day, daily, weekly, and monthly). The minimum price presented to the event organizer may be calculated based on a combination of prices available to make up the length of time set by the organizer (e.g., a 6-hour reservation may be the cheapest as a combination of a half-day and two hours or as a full-day rental depending on the price set by the venue). Additionally, amenities can be priced or free of charge depending on certain criteria.

One or more discounts may be applied based on identity of the event organizer, whether the event organizer is a member of a group, whether the selected venue belongs to a group, whether the reservation is made for the first time, whether a particular type of a credit card is provided for the payment, and so forth. Discounts can be based on coupons available to only an individual user; applicable to all members of a group (e.g., a company), applicable to a particular group of venues, time of use, credit card used, a percentage off the price, a fixed amount, and so forth.

On completing the reservation, the system 200 may update the calendar event information in the calendar service. The system 200 may use a standard permission mechanism of the calendar service to get permission to update the calendar event. For example, details of the reserved venue may be provided in relation to the event. The details may include a web link to a dynamic page containing information about the venue reserved including pictures, address, directions, amenities, and other instructions. Thus, all invitees/attendees may receive up-to-date information about the event. Additionally, updates to the calendar event may be automatically communicated to all invitees/attendees and available on their mobile devices through normal calendar software operation.

Furthermore, when the reservation is completed, the system 200 may collect the payment amount associated with the selected venue and transmitted to an account (e.g., a credit card account, a bank account, and so forth) associated with the selected venue. The payment may be remitted to the venue based on terms agreed to with the venue owner and the specifics of each reservation made by the event organizer.

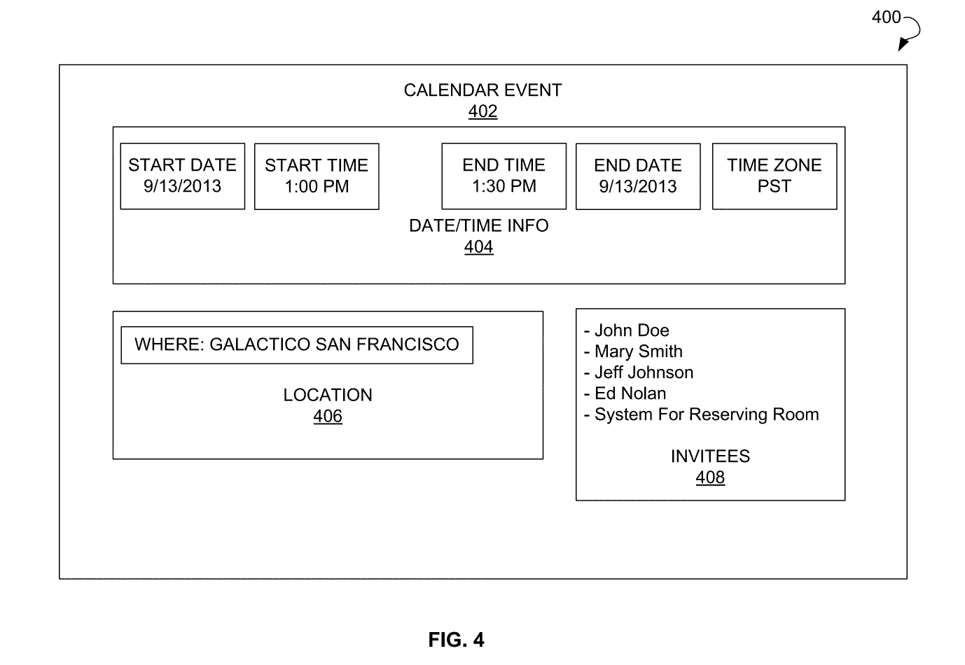

FIG. 4 illustrates an example screen 400 of a calendar event 402, in accordance to some embodiments. The calendar event 402 may include various data specified by the event organizer. Thus, the data may include data/time info 404 (e.g. start date and time, end date and time, time zone, and so forth), location 406 (a desired location for the event), invitees 408, and so forth.

To request that the system 200 start the reservation process, the event organizer may add the system 200 to invitees 408 of the calendar event 402. The system 200 may retrieve the data associated with the event and find suitable venues based on the data. Among the suitable venues, the system 200 may identify and rank optimal venues using information on previous reservations of the organizer and invitees, recommendations of other user, policies of the venue management body and policies of the company associated with the organizer and invitees, and so forth.

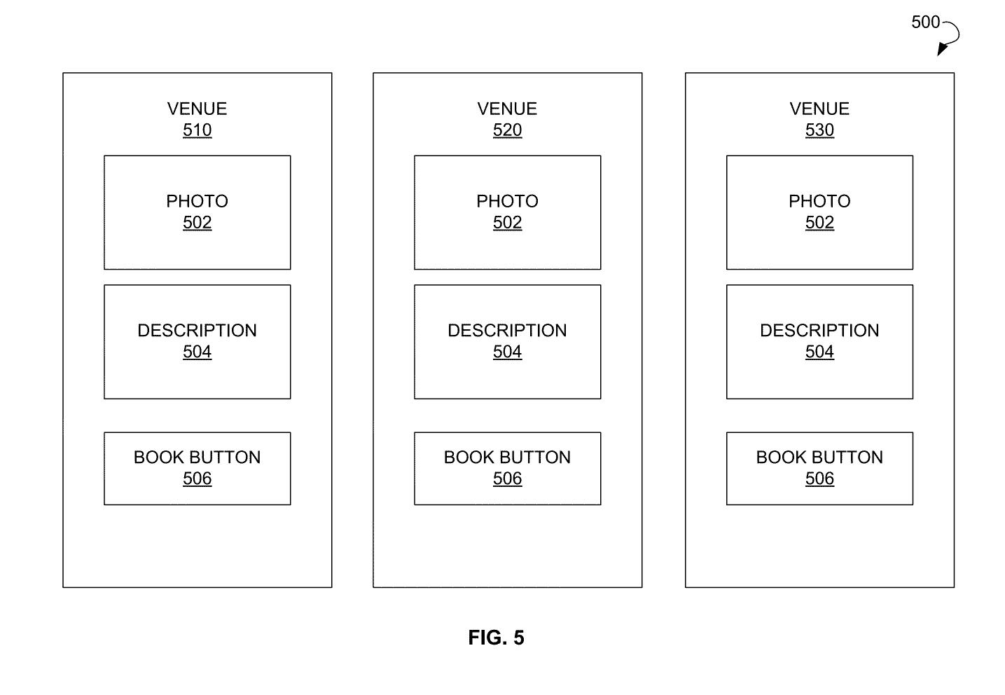

A predefined number of optimal venues with the highest rank may be presented to the event organizer using screen 500 as illustrated by FIG. 5. In some embodiments, the presentation may include one or more advertisements associated with a third party of the system 200. In FIG. 5, the predefined number of suitable venues includes three venues 510, 520, and 530. The venues 510, 520, and 530 may be presented, for example, via an e-mail message sent to the event organizer.

Each of the venues 510, 520, and 530 may be presented with at least a photo 502 of the venue, a description 504, and a control element that may initiate venue reservation (for example, a book button 506). By clicking the book button 506 associated with the desired venue, the event organizer may select the venue and send a request to reserve the venue to the system 200.

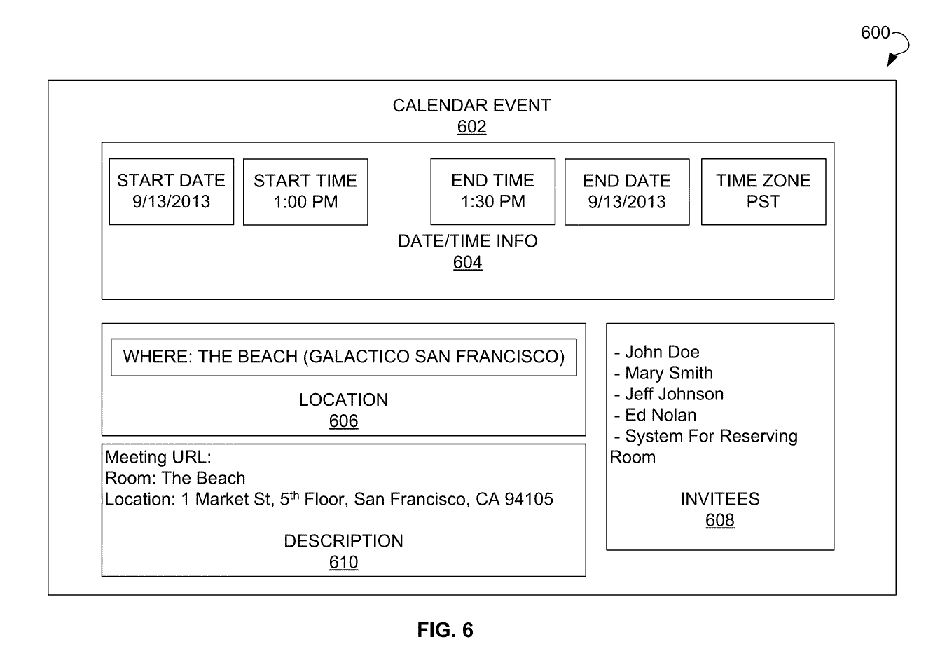

The system 200 may reserve the selected venue and update the data of the calendar event as illustrated by FIG. 6. FIG. 6 illustrates an example screen 600 of an updated calendar event 602, in accordance with some embodiments. Updates may be made to a location 606 and/or a description 610 section to inform the invitees 608 about the exact location of the calendar event 602.

Additionally, the updates may be communicated to the invitees 608 via the calendar service, e-mail, and so forth.

In some embodiments, the event organizer may introduce some changes to the calendar event.

The system 200 may receive the changes and respond correspondingly to make sure that the reservation made for the event (if any) is still suitable. For example, if the date or time of the event is changed, the system may check whether the reserved venue is available for the changed date or time and move the reservation accordingly if the venue is available. A notice confirming that the original venue choice is available may be sent to the event organizer. If the original venue is not available for the changed date or time, alternative venues optimal for the changed data may be presented. The event organizer may select one of the venues and a new reservation may be made.

If more attendees are added to the event, the system may send back a notice confirming that the original venue choice has sufficient capacity for the meeting or suggest alternatives. If the location is changed, the system offers an updated set of choices based on the new input.

In some embodiments, the system 200 can receive information from a client device associated with the event organizer and/or attendees. The information may include a user ID, device location, contacts on the client device, messaging and notification methods, and so forth. Using this information, the system 200 can enable the event organizer to find and book venues via the client device. Additionally, the system 200 may ensure an improved experience on-site through the client device, including notification of the venue operator of the proximity of the event organizer/attendee associated with the client device, the location of the event organizer/attendee within the building, the ability for the event organizer/attendee to request help when on-site, the ability for the event organizer to extend a meeting, the ability for the event organizer/attendee to see when attendees are on-time or running late, the ability to provide wayfinding to the venue location and to the location of the workspace in the building, the ability for the event organizer/attendee to rate the workspace and provide suggestions for improvements to the experience including submitting work orders for repair (e.g., replace a light bulb).

The system 200 may provide notifications to the event organizer and attendees at a predetermined time before the event start. In addition to reminding about the event, the notification can allow the attendee to share status with respect to the event. The status may include “On the way,” “Running late,” “Check in,” “Cancel Meeting,” and other options. Thus, the attendee may inform others that they may be late. Alternatively, the attendee may be in the building already and ready to check in or may, as an event organizer, have decided to cancel the event altogether and free up the room for others to use. The remaining attendees may get a similar message except that they may have an option to decline the event and inform the organizers about their decision. The statuses may be available for all attendees and the event organizer. Furthermore, when the event is over, the attendees may check out. Additionally, the attendees may share their experience with the facilities and leave feedback. This can allow the facilities to improve operations and collect data about the utilization to have more efficient events in the future.

In some embodiments, the calendar event may include a recurring calendar event (for example, a weekly meeting, a monthly session, and so forth). When the reservation is made for an undefined period of time rather than for a specific event, or for the recurring use of the venue for an extended period of time, the payment for the recurring use of the venue may be collected periodically.

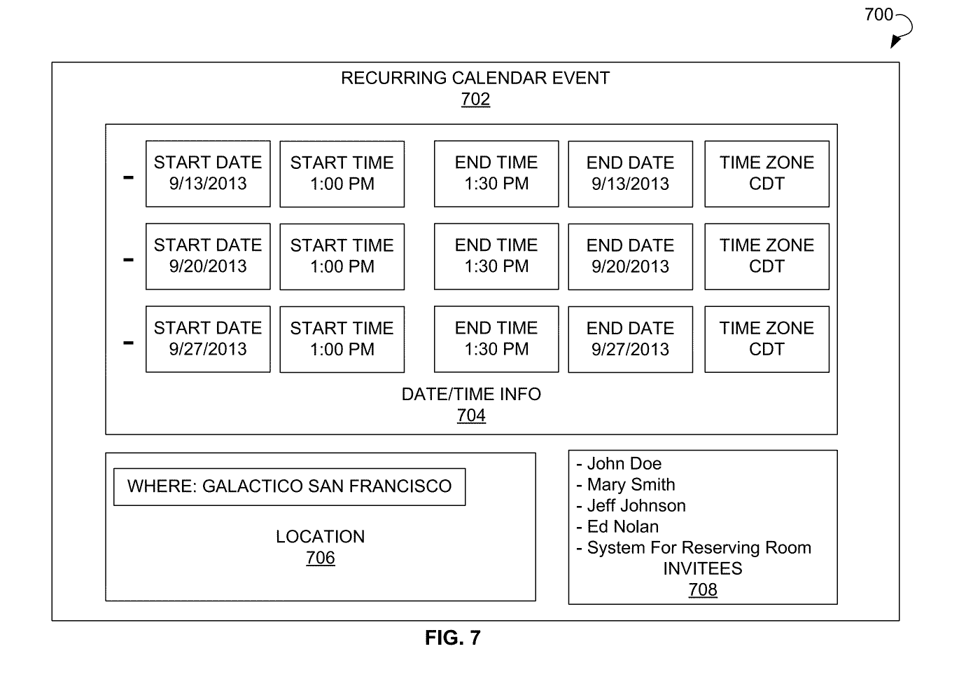

FIG. 7 illustrates an example screen 700 of a recurring calendar event 702, in accordance to some embodiments. The recurring calendar event 702 may be associated with several date/time info 704 sets. Each set may specify a date and time for different instances of the recurring calendar event 702.

Location 706 may specify a desired location for all instances of the recurring calendar event 702, and invitees 708 may include persons invited to all events of the recurring calendar event 702.

The system 200 may gather data for all events and find suitable venues for every event.

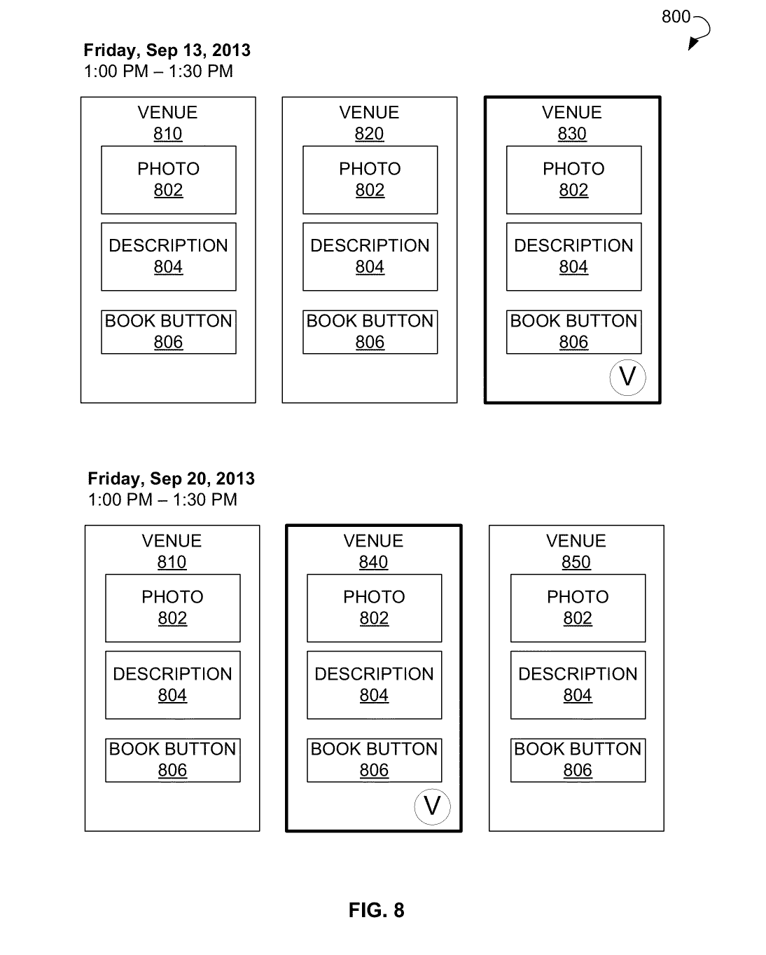

FIG. 8 illustrates an example screen 800 of presenting suitable venues for a recurring event, in accordance with some embodiments.

A predefined number of suitable venues may be proposed for every event instance. Different venues may be available for different dates, so the presentation may include various venues for each date. For example, venues 810, 820, and 830 may be presented for September 13, while the presentation may propose venues 810, 840, and 850 for September 20.

The event organizer may select one of the suitable venues proposed for every instance and the system 200 may reserve the selected venues for every instance of the recurring event.

Additionally, the event organizer may change individual events in a series of a recurring event. Such changes may be processed and handled independently without changing other instances of the recurring event.

The described systems and methods may assist organizations (for example, organizations providing management consulting, technology and outsourcing services) that have more people than desks, in providing efficient workspaces for their employees. The technology may enable organizations with offices in many cities to quickly find space to meet or work and help the organization to maximize their workspace. The technology may be used in specific locations to ensure effectiveness of a mobile workforce and to address occasional peak demand challenges. By using this technology, an organization may potentially delay or avoid expanding its real estate portfolio.

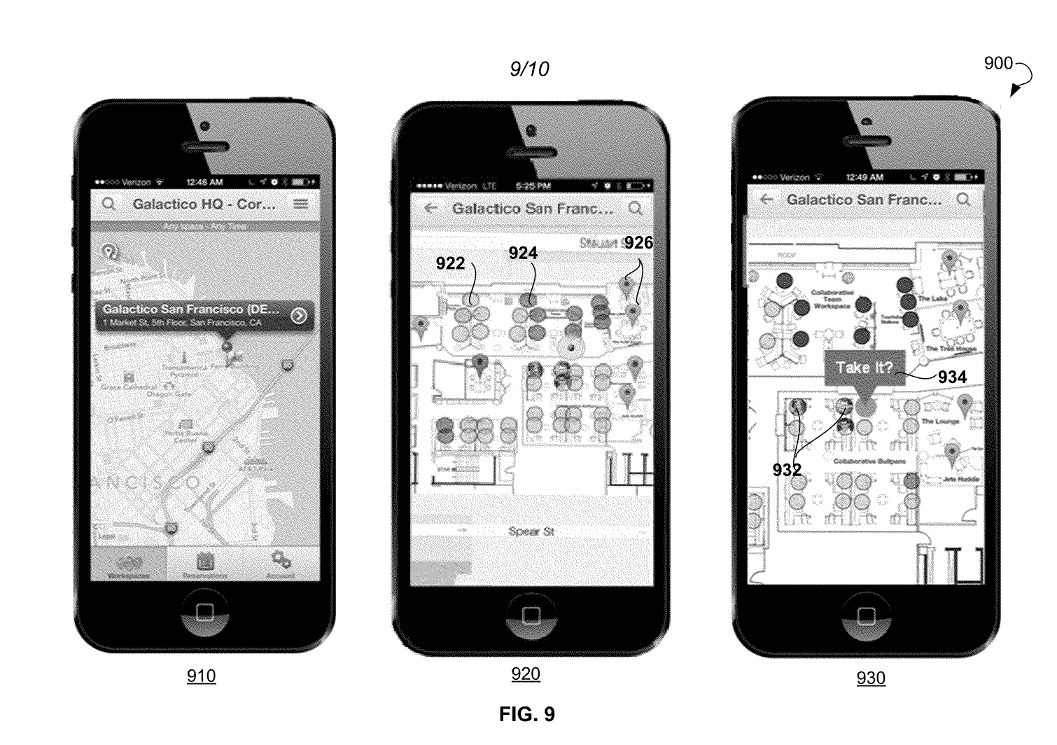

FIG. 9 illustrates example screens for reserving a workplace. A company may have offices across the country and an employee may work at different locations depending on where the offices are located. For example, an employee can be in San Francisco and decide to work from a San Francisco office of the company. The San Francisco office may have implemented the share desking or free address. This means that the employee is not aware whether there is a desk available for him/her and does not know where his/her colleagues are, unless he can go and find them. The systems and methods disclosed herein provide employees with the ability to find their colleagues and a working place next to them. An employee may start the process by clicking on the San Francisco location as shown on screen 910. After selecting the location, the employee may view the floor map of the location as illustrated by screen 920. The floor map visualizes a sitting scheme and available spaces within the scheme. Occupied 922 and available 924 spaces may be differentiated by color or otherwise. Additionally, the floor map may show locations of office facilities 926, such as meeting rooms, printer, fax, and so forth. The employee may review the floor map and find available spaces. Before the employee gets to work, he/she may choose one of the available 924 spaces as shown by screen 930. To book a space, the employee may click “Take It” button 934. Alternatively, the employee may wait until he/she gets to work. When the choice is made, a GPS mark representing the current physical location of the employee based on a location-sensing technology available natively to the mobile device and/or implemented by the system may indicate where the employee location is situated. The employee may use the GPS mark to find his way to meetings or other desks where his colleagues are located.

The employee may see where his colleagues are located because his social connections show up with their faces 932 on the floor map. Alternatively, the employee may search for people by typing their name. For example, an employee may want to work with a specific colleague and sit next to him. He may select this particular space next to his colleague. When the “Take It” 934 is clicked, the system 200 can confirm that the employee has found, booked, and checked into that space. When the space is booked, friends and colleagues of the employee know where he is located because his face appears on the floor map. During a day, if, for example, the employee wants to find a quieter place to work in order to make a phone call, he may select a different available space 924. The previous space of the employee is then released to be used by others and the new space is booked.

The system 200 may track a location of the employee. When the system 200 detects that a work day is over and the location of the employee has changed from the office building to another location, the system 200 may confirm that the employee is gone for the day and checks him/her out of his space. The space then becomes available for the rest of the team.

In some embodiments, office space utilization data, data concerning the employee location, and who the employee works with may be available to real estate and work strategy specialists. Accordingly, these specialists may be able to better layout the building as well as to understand how teams collaborate. It also available in real time for variety of uses ranging from emergency to simply indicating who is in the building at any particular time.

The systems and methods for reserving a venue for a calendar event can provide advantages for employees, company management, corporate real estate executives, and others. Employees may choose a workspace, where and when they desire. They may navigate the pool of available options with ease and confidence from the web, mobile application, or native calendar system, search and find the workspace, whether within the company or at a plurality of public venues, find their team or co-workers in real time and book a workspace near them, thereby saving time on every booking by letting the technology recommend an optimal available workspace, and receive proactive notifications to improve event experience before, during, and after the visit.

The company management may ensure a high performance workplace that defines company culture, engages and retains high performing employees, and delivers on economic results. The technology may enable corporate real estate to engage employees in the shift to a shared workspace environment, reduce real estate costs and carbon footprint, help employees connect and collaborate more productively, provide the employees with a real-time voice about their work experiences by letting them rate and review the workspaces they visit.

Corporate real estate executives may increase the efficiency and engagement of their portfolios, share and manage workspaces easily and at less cost in the marketplace provided by the technology. Corporate real estate executives can also optimize their existing real estate by placing available space on the public or privileged marketplace; extend their portfolio to include third spaces that are on-demand and pay-for-use only. They can also measure, monitor, and report on workspace usage in real-time, view ratings and reviews to better manage workspace, amenities, and meeting services.

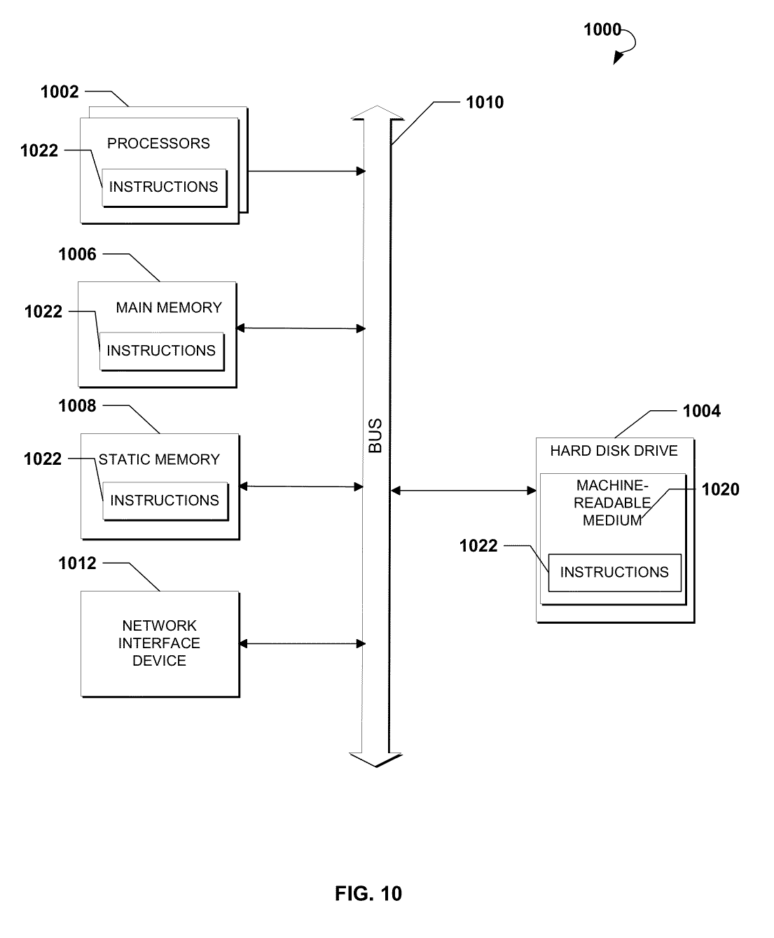

FIG. 10 shows a diagrammatic representation of a machine in the example electronic form of a computer system 1000, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor or multiple processors 1002 (e.g., a CPU, a graphics processing unit (GPU), or both), a main memory 1006 and a static memory 1008, which communicate with each other via a bus 1010. The computer system 1000 may further include a video display unit 1010 (e.g., a liquid crystal display (LCD) or a cathode ray tube (CRT)). The computer system 1000 may also include an alphanumeric input device 1012 (e.g., a keyboard), a cursor control device 1014 (e.g., a mouse), a disk drive unit 1004, a signal generation device 1028 (e.g., a speaker), and a network interface device 1012.

The disk drive unit 1004 includes a non-transitory computer-readable medium 1020, on which is stored one or more sets of instructions and data structures (e.g., instructions 1022) embodying or utilized by any one or more of the methodologies or functions described herein. The instructions 1022 may also reside, completely or at least partially, within the main memory 1006 and/or within the processors 1002 during execution thereof by the computer system 1000. The main memory 1006 and the processors 1002 may also constitute machine-readable media.

The instructions 1022 may further be transmitted or received over a network 1026 via the network interface device 1012 utilizing any one of a number of well-known transfer protocols (e.g., Hyper Text Transfer Protocol (HTTP)).

In some embodiments, the computer system 1000 may be implemented as a cloud-based computing environment, such as a virtual machine operating within a computing cloud. In other embodiments, the computer system 1000 may itself include a cloud-based computing environment, where the functionalities of the computer system 1000 are executed in a distributed fashion. Thus, the computer system 1000, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as the computing device 130, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, methods and systems for for reserving a venue for a calendar event have been disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for reserving a venue for a calendar event, the method comprising:
receiving, by a processor, an invitation to the calendar event from an event organizer;
gathering, by the processor, data associated with the calendar event;
defining, by the processor, event requirements based on the data associated with the calendar event;
determining, by the processor, one or more suitable venues based on the event requirements and a permission associated with the event organizer;
identifying, by the processor, one or more optimal venues based at least on information associated with the event organizer and the one or more suitable venues;
presenting, via a user interface, the one or more optimal venues to the event organizer;
receiving, by the processor, from the event organizer, a selected venue, the selected venue being selected from the one or more optimal venues, and payment information to collect a payment amount associated with the selected venue; and
reserving, by the processor, the selected venue.

2. The method of claim 1, wherein the data associated with the calendar event includes one or more of the following: a date, a time, a number of invitees, identities of the invitees, and a desired location.

3. The method of claim 1, wherein the one or more suitable venues include venues that grant permissions to the event organizer to reserve a venue.

4. The method of claim 1, wherein granting the permission is based on at least one of the following: a list of potential individuals to be invited to the venue, an invite to an individual, the event organizer being a member of a group, an analysis of a profile of the event organizer during a reservation process, an analysis of the event organizer by a reservation system.

5. The method of claim 1, wherein the permission defines at least one of the following: allowed hours of operation, days of access, a lead time before the reserving is made, an allowed payment method, one or more transactions associated with the reservation, cancellation policies, workspaces available within the venue, a size of payment, wherein the permission vary depending on the event organizer.

6. The method of claim 1, wherein the permission includes one or more data objects associated with each individual and each venue associated with each individual.

7. The method of claim 1, wherein the permission includes one or more types being determined based on a way of the event organizer encountering the reservation system, including at least one of the following: an invitation by the venue, a result of a query entered in a search system, the event organizer being a member of a group.

8. The method of claim 1, wherein the permission allows a venue listing to be visible to everyone or visible to invited users only.

9. The method of claim 1, wherein the presenting of the one or more suitable venues to the event organizer includes one or more of the following: sending an email, presenting on a web site, presenting via a mobile application, and sending via mobile communications.

10. The method of claim 1, wherein the one or more optimal venues are limited by a predetermined number.

11. The method of claim 1, further comprising updating, by the processor, the data associated with the calendar event in response to the reserving.

12. The method of claim 1, wherein the price of the selected venue is determined by at least one of the following: a price set by the venue, a duration of the calendar event associated with the selected venue, one or more amenities associated with the calendar event, the permission granted by the venue, a tax rate entered by the venue, and one or more discounts applied to the reservation.

13. The method of claim 12, wherein the one or more discounts are applied based on one or more of the following: an identity of the event organizer, whether the event organizer is a member of a group, whether the selected venue belongs to a group, whether the reservation is a first-time reservation, and whether a particular type of a credit card is provided to collect the payment amount.

14. The method of claim 1, wherein the price provided to the event organizer is determined as a minimum price of the venue according to the event requirements.

15. The method of claim 1, wherein the payment information includes an authorization for the collection of the payment amount, the authorization being provided individually by the event organizer or by a sponsor of a group where the price is charged against a centrally billed account.

16. The method of claim 1, further comprising:
receiving, by the processor, a request for the venue, wherein the request includes general requirements without a specific period of time.

17. The method of claim 16, wherein the request is associated with a recurring use of the venue during an extended period of time, the payment amount for the recurring calendar event being collected periodically.

18. The method of claim 1, further comprising:
receiving, via the user interface, from the event organizer, one or more changes to the calendar event;
defining, by the processor, changed event requirements based on the one or more changes; and
determining, by the processor, one or more further optimal venues based on the changed event requirements.

19. The method of claim 18, further comprising:
presenting, via the user interface, the one or more further optimal venues to the event organizer; and
receiving, by the processor, from the event organizer, a selected venue, the selected venue being selected from the one or more optimal venues.

20. The method of claim 1, wherein the calendar event includes a recurring calendar event, and the presenting of the one or more optimal venues includes the one or more optimal venues for every instance of the recurring calendar event.

21. The method of claim 20, wherein changes to the recurring calendar event are handled independently for each instance of the recurring calendar event.

22. The method of claim 1, wherein the payment amount is transmitted to an account associated with the selected venue according to one or more agreed to terms.

23. A system for reserving a venue for a calendar event, the system comprising:
a processor configured to:
receive an invitation to the calendar event from an event organizer;
gather data associated with the calendar event;
define event requirements based on the data associated with the calendar event;
determine one or more suitable venues based on the event requirements;
identify, by the processor, one or more optimal venues based at least on information associated with the event organizer and the one or more suitable venues;
present, via a user interface, the one or more optimal venues to the event organizer;
receive, from the event organizer, a selected venue, the selected venue being selected from the one or more optimal venues; and
reserve the selected venue;
a database communicatively coupled to the processor and configured to store at least a plurality of available venues, the data associated with the calendar event, the event requirements, the one or more suitable venues, the one or more optimal venues, and the selected venue.

24. The system of claim 23, wherein the data associated with the calendar event includes date and time of the calendar event, number and identity of invitees to the calendar event, and desired location of the calendar event.

25. The system of claim 23, wherein the one or more optimal venues are limited by a predefined number.

26. The system of claim 23, wherein the processor is further configured to update the data associated with the calendar event.

27. The system of claim 23, wherein the processor is further configured to:
receive one or more changes to the calendar event;
define changed event requirements based on the one or more changes; and
determine whether the selected venue is still suitable based on the changed event requirements.

28. The system of claim 27, wherein the processor is further configured to provide a confirmation that the selected venue is still suitable based on the checking.

29. The system of claim 27, wherein the processor is further configured to:
determine one or more further optimal venues based on the changed event requirements if the selected venue is no longer suitable;
present the one or more further optimal venues to the event organizer;
receive, via the user interface, from the event organizer, a further selected venue, the further selected venue being selected from the one or more further optimal venues; and
reserve the further selected venue.

30. The system of claim 29, further comprising cancelling the selected venue.

31. The system of claim 23, wherein the calendar event includes a recurring calendar event, and the presenting of the one or more optimal venues include the one or more optimal venues for each instance of the recurring calendar event.

32. The system of claim 23, wherein changes to the recurring calendar event are independent for each instance of the recurring calendar event.

33. A non-transitory computer-readable storage medium having embodied thereon a program, the program being executable by a processor to perform a method for reserving a room for a calendar event, the method comprising:
receive an invitation to a calendar event from an event organizer;
gather data associated with the calendar event;
define event requirements based on the data associated with the calendar event;
determine one or more suitable venues based on the event requirements;
identify one or more optimal venues based at least on information associated with the event organizer and the one or more suitable venues;
present the one or more optimal venues to the event organizer;
receive, from the event organizer, a selected venue, the selected venue being selected from the one or more optimal venues; and
reserve the selected venue.
